(19) United States
(12) Patent Application Publication
(10) Pub. No.: US 2017/0261142 A1
(43) Pub. Date: Sep. 14, 2017

(54) Method for Manufacturing a Measuring Tube

(71) Applicant: Endress + Hauser Wetzer GmbH + Co. KG, Nesselwang (DE)

(72) Inventor: Stephan Wiedemann, Bihlendorf (DE)

(21) Appl. No.: 15/504,098

(22) PCT Filed: Jul. 16, 2015
(86) PCT No.: PCT/EP2015/066270

§ 371 Date: Feb. 15, 2017

(30) Foreign Application Priority Data
Aug. 21, 2014 (DE) 10 2014 111 985.1

(51) Int. Cl. F16L 41/00; G01K 1/08; G01K 13/02

(52) U.S. Cl. CPC F16L 41/008; G01K 13/02; G01K 1/08

(57) ABSTRACT

A method for manufacturing a measuring tube, which serves for conveying a measured substance, which measuring tube comprises a pipeline having a lumen, into which lumen an immersion body protrudes. The immersion body is connected with a formed piece, and the formed piece is connected with the pipeline in such a manner that a vacancy in the wall of the pipeline is essentially measured substance tightly, for example, gas tightly and/or liquid tightly, sealed by the formed piece.

The invention relates to a method for manufacturing a measuring tube, a measuring tube obtained by the method and a measuring system having such a measuring tube.

Currently, great demands are placed on thermometers for applications in sterile processes, in which a product is made from a raw or starting material by the application of chemical, physical or biological procedures. In such case, the measuring devices must register a measured value as exactly as possible and simultaneously fulfill requirements of sterile production. The integration of the sensor into the process must occur as dead space- and gap-freely as possible, in order to offer deposits, respectively biofilm formation, no points of attachment and in order to enable residue free cleaning. This problem is explained, for example, in the article “Totraumfreies Schutzrohr (Dead Space Free, Protective Tube)” retrievable at http://www.prozesstechnik-online.de/firmen /-/article/31534493/37267194/Totraumfreies-Schutzrohr /art—co—INSTANCE—0000/maximized/. Proposed in Offenlegungsschrift DE 102010037994 A1 is a measuring point for measuring a physical variable, composed of a tube section having an opening, in which an adapter is tightly secured, which can accommodate a measuring probe, wherein the tube section has a flat spot providing a flattening, respectively a planar area, with an opening, wherein the adapter fills out the opening in the flattened tube section and the adapter is connected by a material connection with the flattened tube wall in the plane of the opening or in a plane parallel to the area of the flat spot.

Known, furthermore, from DE 102012112579 A1 is a receiving apparatus for a measuring insert, especially preferably one for temperature determination, which receiving apparatus serves for accommodating the measuring insert, wherein the receiving apparatus has a first section and a second section, which are separated from one another via a shoulder, wherein the shoulder has a shape, which essentially corresponds to a section of the lateral surface of a tubelike wall of a process container, for example, a pipeline or a tank, into which wall the receiving apparatus is insertable.

An object of the invention is to provide an alternative for manufacturing a hygienic thermometer, especially without having to deform the tube section, respectively to change its cross section.

The object is achieved according to the invention by a method, a measuring tube and a measuring system.

As regards the method, the object is achieved by a method for manufacturing a measuring tube, which serves for conveying a measured substance, which measuring tube comprises a pipeline having a lumen, into which lumen an immersion body protrudes, wherein the immersion body is connected with a formed piece, and wherein the formed piece is connected with the pipeline in such a manner that a vacancy in the wall of the pipeline is essentially measured substance tightly sealed by the formed piece.

The measuring tube is, for example, a part of a pipeline or a pipeline section, in which a measuring transducer is integrated or to which a measuring transducer is mounted, in order to determine the chemical and/or physical measured variable of a measured substance, which is located in the pipeline. In such case, an immersion body is provided, for example, in the form a protective tube, into which protective tube, for example, a measuring insert, preferably one for determining temperature, can be introduced. The immersion body can, however, also, be, for example, a Pitot tube or other bluff body, which protrudes into the lumen of the tube. The pipeline can, in such case, be, for example, of a metal material. However, also pipelines of plastic are known.

The immersion body is connected at a first joint with a formed piece, which formed piece surrounds the immersion body, preferably completely surrounds the immersion body. The connection is, for example, a material bonded connection between the material of the immersion body at the first joint and the material of the formed piece at the first joint.

The immersion body is, in such case, essentially centered, respectively centrally arranged, in the formed piece.

Then, the formed piece (including the immersion body now fixedly connected therewith) can be connected with the pipeline at a second joint. This can likewise be a material bonded connection between the material of the formed piece at the second joint and the material of the pipeline at the second joint.

The formed piece is, in such case, formed and connected with the pipeline in such a manner that a vacancy, such as, for example, an opening, in the wall of the pipeline, through which opening, for example, the lumen is connected with the environment of the pipeline, is sealed by the formed piece preferably gas- and/or liquid tightly.

In a form of embodiment of the method, a piece of the tube wall, especially a tube wall section taken from the pipeline, serves as the formed piece. The formed piece can be won from the pipeline, into which it is later reinserted, after the immersion body has been connected with the formed piece.

The formed piece corresponds preferably to a section of the wall of the pipeline. The vacancy in the pipeline corresponds then to the formed piece and forms its negative.

In an additional form of embodiment of the method, the vacancy is formed by removing a piece of the wall of the pipeline. In such case, the formed piece can be removed from the pipeline by one or more cuts. For example, the formed piece can be removed from the pipeline by a first cut, a second cut, for example, parallel to the first cut, and a third cut, which connects the first and second cuts with one another. The at least one cut can, in such case, be done by laser, drilling, sawing, punching, or milling. In the case of the at least one cut, it can be a straight cut or a profiled cut. The first and second cuts can be spaced from one another offset along the tube axis and extend, for example, perpendicularly to the longitudinal axis of the pipeline. The third cut can then extend, for example, parallelly to tube axis, preferably through the tube axis.

The vacancy can be, for example, a hole in the pipeline, for example, a central hole or an eccentric hole, with or without miter.

In an additional form of embodiment of the method, the vacancy is provided especially window shaped or terminally in the pipeline. In the case of a window shaped cut, such can be, for example, a hole in the pipeline with a circularly shaped, elliptical or polygonal contour on the outside or the inside of the pipeline. Terminally arranged means that the vacancy is arranged at an end of the tube.

The pipeline can be, for example, a round tube, a square tube, a rectangular tube or a tube with a bend in it.

In an additional form of embodiment of the method, the removed tube wall section is reconnected with the pipeline.

In an additional form of embodiment of the method, the formed piece, especially the removed tube wall section, has an essentially arc shaped cross section.

In an additional form of embodiment of the method, a sensor element is placed in the immersion body. For example, a measuring transducer for determining temperature, preferably in the form a measuring insert at whose tip the measuring transducer is arranged, can be placed in the immersion body.

In an additional form of embodiment of the method, used as immersion body is a protective tube, which serves for accommodating a sensor element. The protective tube is, in such case, preferably embodied measured substance tightly. The measured substance is, for example, a gas and/or a liquid.

In an additional form of embodiment of the method, the immersion body is welded with the formed piece. For example, the formed piece can have an inside, which in the installed state faces the lumen of the pipeline, and an outside, which in the installed state faces the environment of the pipeline. In such case, it is advantageous that the immersion body can be processed from the inside of the formed piece. For example, a welding can be performed from the inside, in order to connect the immersion body with the formed piece. Additionally, a processing, for example, a welding, can also be performed from the outside of the formed piece, especially in order to connect the immersion body with the formed piece.

In an additional form of embodiment of the method, a weld seam between the immersion body and the formed piece is smoothed or otherwise processed, before the formed piece is connected with the pipeline.

In an additional form of embodiment of the method, the immersion body is connected, preferably welded, with the formed piece in such a manner that a radius between the immersion body and the formed piece satisfying hygiene regulations is formed. Hygiene regulations require, for example, a surface perfection characterized by an average roughness Ra<0.38 μm.

In an additional form of embodiment of the method, the connection formed between immersion body and formed piece is processed in such a manner, preferably polished and/or ground, that a surface perfection between the immersion body and the formed piece satisfying hygiene regulations is produced.

In an additional form of embodiment of the method, the formed piece is removed from the tube wall by means of a laser- or plasma cutting method.

In an additional form of embodiment of the method, the formed piece is connected with the pipeline by means of a welding method.

In an additional form of embodiment of the method, a weld seam between the formed piece and the pipeline at the lumen of the measuring tube is smoothed, for example, by grinding and/or polishing the weld seam. The weld seam can be located, for example, on the inside of the formed piece.

The formed piece can preferably have the same wall thickness as the wall of the pipeline. The formed piece is, in such case, preferably arranged aligned with, i.e. flush with, the inner wall of the pipeline.

As regards the measuring tube, the object is achieved by a measuring tube obtained by the method of one of the preceding forms of embodiment.

In a form of embodiment of the measuring tube, the pipeline is a T-piece or an elbow.

As regards the measuring system, the object is achieved by a measuring system having a measuring tube according to one of the forms of embodiment of the measuring tube, wherein the immersion body includes a measuring transducer for determining temperature. The measuring system can, thus, be used for determining the absolute temperature. Furthermore, it is also possible to use the measuring system for determining a flow through the measuring tube, for example, based on the calorimetric measuring principle or the vortex measuring principle.

Furthermore, also a number of immersion bodies can be mounted in the formed piece and then the formed piece connected with the pipeline. For example, one immersion body can serve for producing vortices in the measured substance, while another immersion body serves for registering the vortices. On the other hand, a heating element can be located in a first immersion body and in another immersion body, spaced therefrom, a temperature sensor for registering the temperature in the measured substance.

The invention will now be explained in greater detail based on the appended drawing, the figures of which show as follows:

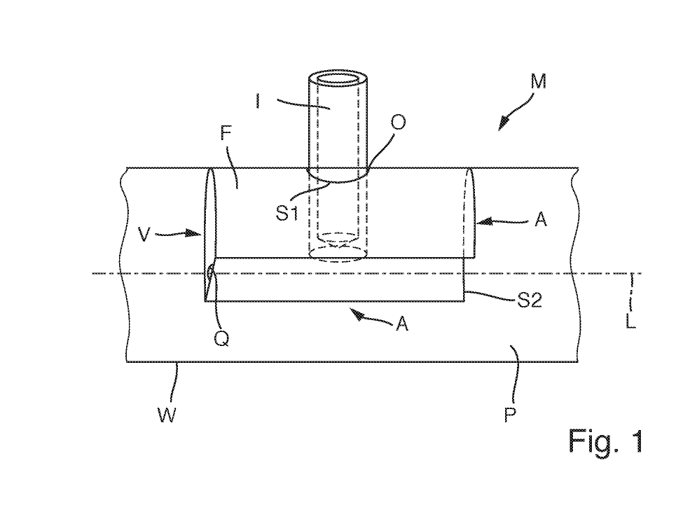

FIG. 1 a schematic representation of one form of embodiment of a measuring tube comprising a pipeline, a formed piece and an immersion body, and

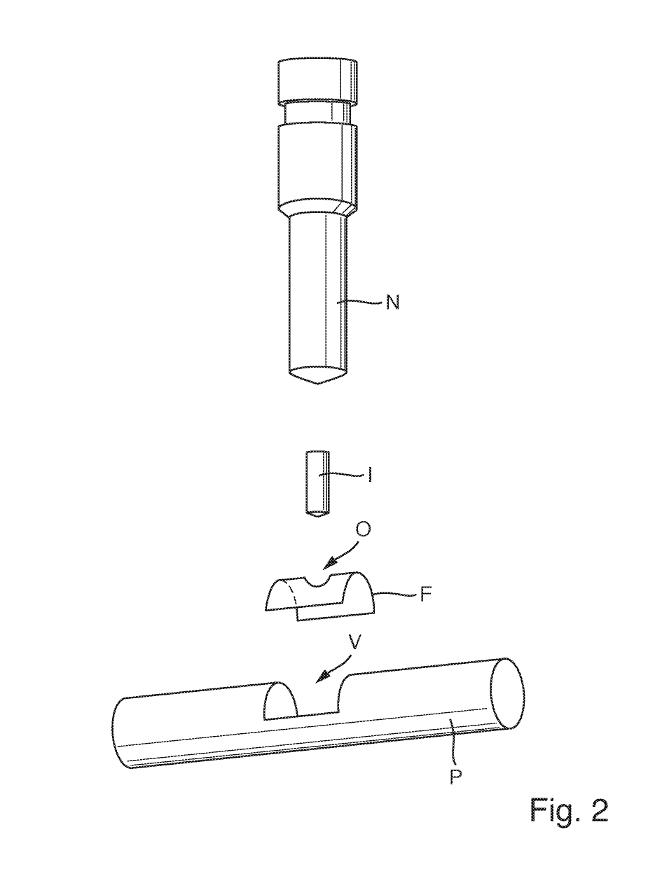

FIG. 2 an exploded view of an additional form of embodiment of a measuring tube comprising a pipeline, a formed piece, an immersion body and a neck tube.

FIG. 1 shows a form of embodiment of a measuring tube M, which comprises a pipeline P, which serves for conveying, for example, a flowing, measured substance. Inserted in a vacancy V in the pipeline P is a formed piece F corresponding to the vacancy. The vacancy V is sealed by the formed piece F. Arranged centrally in the formed piece F in an opening O in the pipeline P is an immersion body I. The immersion body I is likewise embodied in the form of a tube, which has a base, which protrudes into the lumen of the pipeline P.

The immersion body I serves here for accommodating a measuring insert (not shown), which can be introduced into the immersion body I. Suitable (virtually) standardized measuring inserts are known, for example, for temperature measurement.

The measuring tube M includes a first, for example, welded, connection S2 between the formed piece F and the pipeline P. Furthermore, the measuring tube M includes a second, for example, welded, connection S1 between the formed piece F and the immersion body I.

The measuring tube M can be produced, in such case, for example, as described in the following. Cut out from a pipeline P, such as, for example, a round tube, is a formed piece F, so that an opening O is formed in the pipeline P, which connects the lumen of the pipeline P with the environment of the pipeline P. The formed piece F, respectively the vacancy V, has, in such case, preferably in cross section perpendicular to the longitudinal axis L, which serves as polar axis, a polar angle θ of greater than 45° . Preferably, the polar angle θ predetermined by the vacancy, respectively the formed piece, amounts to essentially 180° .

The proposed connection between the immersion body and the formed piece, respectively between the formed piece and the pipeline P, enables a hygienic welding of the components. The corresponding regulations prohibit a sharp edged transition between the components, since then the danger of material attachments is present. Rather, according to regulation, a radius, respectively a certain angle and/or a certain surface quality, must be present; compare, for example, Offenlegungsschrift DE 102012112579 A1.

Here, for example, a formed piece F can be removed from the pipeline P with the assistance of a 3D cutting machine, for example, by means of a laser- or plasma cutting method. The immersion body in the form of a tube wall section can be welded into this formed piece F. Because the formed piece F, when removed, is accessible from both sides, the weld seam S1 can be produced conforming to standard. In such case, for example, the radius of the transition between the immersion body and the formed piece can be polished.

Then, the formed piece F is welded back into the pipeline P. This welded seam S2 can now also be worked further from the inside, since the immersion body does not hinder the processing, respectively no longer must be processed. With suitable tools, thus the weld seam S2 can be ground and/or polished.

FIG. 2 shows a form of embodiment of the proposed invention in an exploded view. In a vacancy V of the pipeline, a formed piece F, in which an immersion body I, for example, a tubular immersion body I, has already been mounted, is connected with the pipeline P. The immersion body is, thus, first of all, placed in an opening O of the formed piece F and connected with the formed piece.

The immersion body I is, for example, tubularly embodied and includes a closed end, which serves to extend into the lumen of the pipeline. Furthermore, the immersion body I includes an open end lying opposite the closed end, into which a sensor element can be inserted.

The immersion body I is, in such case, introduced in such a manner into the opening that the edge of the open end of the immersion body is arranged flush with the surface of the formed piece. Alternatively, the immersion body I can, such as shown in FIG. 1, extend out on both sides of the formed piece F.

Preferably, the immersion body I protrudes in the installed state no more than half the tube diameter of the pipeline P into the lumen of the pipeline P.

From a round tube, which is straight or bent, and serves as pipeline P, a part of the wall, which serves as the formed piece, can be removed. Then, in this formed piece, a hole serving as opening O can be drilled and the immersion body inserted into this hole. Following this, the immersion body I can be welded with the formed piece F. The resulting weld seam can then be processed from both sides of the formed piece, i.e. the side facing the lumen of the pipeline in the installed state and the side facing the environment of the pipeline in the installed state. In such case, for example, a desired roughness of the formed piece and of the immersion body can be produced and/or a desired radius of the welded connection can be produced. Then, the formed piece can be welded back into the pipeline. Also, this weld seam can then be subsequently processed, since the welded-on immersion body does not hinder the processing.

Furthermore, a so-called neck tube N can be provided, which is likewise connected with the pipeline P and which is arranged in such a manner that the immersion body I is arranged within the neck tube N on the side of the pipeline P facing the environment. The neck tube can serve, for example, to accommodate connection lines to the sensor element or a measurement signal processing electronics

The proposed invention offers, thus, the advantage that a dead space free, measuring tube is created, which manages without a cross-section change of the pipeline. Furthermore, the welded seams can be processed in simple manner, in order to assure meeting of the requirements as regards application in plants, which must satisfy hygiene specifications.

1-17. (canceled)

18. A method for manufacturing a measuring tube, which serves for conveying a measured substance, which measuring tube comprises a pipeline having a lumen, into which lumen an immersion body protrudes;
the method comprising the steps of:
providing a formed piece with the immersion body;
connecting the immersion body with the formed piece; and
sealingly connecting the formed piece with the pipeline in such a manner that a vacancy in the wall of the pipeline is essentially sealed tightly by the formed piece against the measured substance, for example, a gas and/or a liquid.

19. The method as claimed in claim 18, wherein:
a piece of the tube wall, especially a tube wall section, is removed from the pipeline and serves as the formed piece.

20. The method as claimed in claim 18, wherein:
the vacancy is formed by removing a piece of the wall of the pipeline.

21. The method as claimed in claim 18, wherein:
the vacancy is provided especially window shaped or terminally in the pipeline.

22. The method as claimed in claim 19, wherein:
the removed tube wall section is reconnected with the pipeline.

23. The method as claimed in claim 19, wherein:
the formed piece, especially the removed tube wall section, has an essentially arc shaped cross section.

24. The method as claimed in claim 18, further comprising the step of:
placing a sensor element in the immersion body.

25. The method as claimed in claim 24, wherein:
there is used as the immersion body a tubular protective tube, which serves for accommodating the sensor element.

26. The method as claimed in claim 18, wherein:
the immersion body is welded with the formed piece.

27. The method as claimed in claim 18, further comprising the step of:
smoothing a weld seam between the immersion body and the formed piece, before the formed piece is connected with the pipeline.

28. The method as claimed in claim 18, wherein:
the immersion body is connected, preferably welded, with the formed piece in such a manner that a radius between the immersion body and the formed piece satisfying hygiene regulations is formed.

29. The method as claimed in claim 18, wherein:
the formed piece is removed from the tube wall by means of a laser- or plasma cutting method.

30. The method as claimed in claim 18, wherein:
the formed piece is connected with the pipeline by means of a welding method.

31. The method as claimed in claim 18, wherein:
a weld seam between the formed piece and the pipeline at the lumen of the measuring tube is smoothed, for example, by grinding and/or polishing the weld seam.

32. A measuring tube, which serves for conveying a measured substance, said measuring tube comprising a pipeline having a lumen, into which lumen an immersion body protrudes;
said measuring tube produced by a method comprising the steps of: providing a formed piece with the immersion body;
connecting the immersion body with the formed piece; and
sealingly connecting the formed piece with the pipeline in such a manner that a vacancy in the wall of the pipeline is essentially sealed tightly by the formed piece against the measured substance, for example, a gas and/or a liquid.

33. A measuring tube as claimed in claim 32, wherein:
said pipeline is a T-piece or an elbow.

34. A measuring system having a measuring tube as claimed in claim 32, wherein the immersion body includes a measuring transducer for determining temperature.
